(19) United States
(12) Patent Application Publication
(10) Pub. No.: US 2017/0043995 A1
(43) Pub. Date: Feb. 16, 2017

(54) STATIC AND DYNAMIC DISPLAY DISPENSER FOR IN-LINE FLUID FLOW, APPARATUS, SYSTEM, AND A METHOD THEREOF

(71) Applicants: Ovid Forest Reichelt, Hyde Park, NY (US); Denis S. Barry, Poughkeepsie, NY (US)

(72) Inventors: Ovid Forest Reichelt, Hyde Park, NY (US); Denis S. Barry, Poughkeepsie, NY (US)

(21) Appl. No.: 15/234,656

(22) Filed: Aug. 11, 2016

Related U.S. Application Data
(60) Provisional application No. 62/205,525, filed on Aug. 14, 2015.

(51) Int. Cl. B67D 1/08; B67D 1/14

(52) U.S. Cl. CPC B67D 1/0855; B67D 1/0874; B67D 1/0877; B67D 1/1477

(57) ABSTRACT

The present invention relates generally to a static and dynamic display dispenser for in-line fluid flow, apparatus, system, and a method of using same. More particularly, the invention encompasses an inventive fluid measuring apparatus having a tap shell housing or handle, a tap head or frame, at least one display screen, a tap stem, and a tap adaptor to connect the tap shell housing or handle to a tap spigot system. The inventive fluid measuring apparatus has at least one means to measure in real-time the fluid or liquid that is being dispensed. The inventive fluid measuring apparatus has at least one means to transmit the collected data to at least one other electronic device via a wired or wireless connection. The invention also allows for the display of at least one image. The invention also provides a method of using the inventive fluid measuring apparatus.

### CROSS-REFERENCE TO RELATED APPLICATION

The instant patent application claims priority to and the benefit of pending U.S. Provisional Patent Application Ser. No. 62/205,525, filed on Aug. 14, 2015, titled “Static And Dynamic Display Dispenser For In-Line Fluid Flow, Apparatus, System, And A Method Thereof,” the entire disclosure of which provisional application is incorporated herein by reference.

### FIELD OF THE INVENTION

The present invention relates generally to a static and dynamic display dispenser for in-line fluid flow, apparatus, system, and a method of using same. More particularly, the invention encompasses an inventive fluid measuring apparatus having a tap shell housing or handle, a tap head or frame, at least one display screen, a tap stem, and a tap adaptor to connect the tap shell housing or handle to a tap spigot system. The inventive fluid measuring apparatus has at least one means to measure in real-time the fluid or liquid that is being dispensed. The inventive fluid measuring apparatus has at least one means to transmit the collected data to at least one other electronic device via a wired or wireless connection. The invention also allows for the display of at least one image. The invention also provides a method of using the inventive fluid measuring apparatus.

### PURPOSES AND SUMMARY OF THE INVENTION

The invention is a novel fluid measuring apparatus and a method of using same.

Therefore, one purpose of this invention is to provide a fluid measuring apparatus having a tap shell housing or handle, a tap head or frame, a display screen, a tap stem, and a tap adaptor to connect the tap shell housing to a tap spigot system.

Another purpose of this invention is to provide a decorative or stylistic or themed or fancy display or screen to a fluid measuring apparatus.

Yet another purpose of this invention is to provide a decorative or stylistic or themed or fancy tap head or frame to a fluid measuring apparatus.

Still yet another purpose of this invention is to provide at least one location for the display of at least one decorative element.

Therefore, in one aspect this invention comprises an in-line fluid flow measuring apparatus, comprising,
(a) a tap shell housing having a tap stem at one end, and a tap head at an opposite end;
(b) said tap head having at least one digital display screen;
(c) said tap stem having a tap adaptor, wherein said tap adaptor securely engages with a tap spigot system; and
(d) said spigot system having at least one line connection with at least one fluid dispenser at one end, and at least one opening at an opposite end for dispensing of said at least one fluid.

In another aspect this invention comprises an in-line fluid flow measuring apparatus, comprising,
(a) a tap shell housing having a tap stem at one end, and a tap head at an opposite end;
(b) said tap head having at least one digital display screen;
(c) said tap stem having a tap adaptor, wherein said tap adaptor securely engages with a tap spigot system;
(d) said spigot system having at least one line connection with at least one fluid dispenser at one end, and at least one opening at an opposite end for dispensing of said at least one fluid; and
(e) at least one movement sensor secured to said tap shell housing, and wherein said at least one movement sensor measures a movement and duration from a first position to a second position of said tap shell housing, and uses said measured information to calculate an amount of said at least one fluid that has been dispensed via said at least one opening of said spigot system.

In yet another aspect this invention comprises a method of measuring an in-line fluid flow, comprising,
(a) providing a tap shell housing having a tap stem at one end, and a tap head at an opposite end;
(b) securing at least one digital display screen to said tap head;
(c) providing at least one tap adaptor between said tap stem and a tap spigot system, wherein said spigot system has at least one line connection with at least one fluid dispenser at one end, and at least one opening at an opposite end for dispensing of said at least one fluid; and
(d) securing at least one movement sensor to said tap shell housing, and wherein said at least one movement sensor measures a movement and duration from a first position to a second position of said tap shell housing when said tap shell housing is moved, and uses said measured information to calculate an amount of said at least one fluid that has been dispensed via said at least one opening of said spigot system.

### BRIEF DESCRIPTION OF THE DRAWINGS

The invention may best be further understood by reference to the ensuing detailed description in conjunction with the drawings in which:

FIG. 1, illustrates a perspective view of an inventive fluid measuring apparatus, according to one embodiment of this invention.

FIG. 2, illustrates a side view of an inventive tap spigot apparatus that provides a connection between the inventive fluid measuring apparatus of FIG. 1, and a fluid dispenser.

FIG. 3, illustrates a perspective view of an inventive fluid measuring apparatus, according to a second embodiment of this invention, which has been mated with an inventive tap spigot apparatus.

FIG. 4, illustrates a front view of an inventive fluid measuring apparatus, according to a third embodiment of this invention.

FIG. 5, illustrates a front view of an inventive fluid measuring apparatus, according to a fourth embodiment of this invention.

FIG. 6, illustrates a front view of an inventive fluid measuring apparatus, according to a fifth embodiment of this invention.

FIG. 7, illustrates a front view of an inventive fluid measuring apparatus, according to a sixth embodiment of this invention.

FIG. 8, illustrates a front view of an inventive fluid measuring apparatus, according to a seventh embodiment of this invention.

FIG. 9, illustrates a front view of an inventive fluid measuring apparatus, according to an eighth embodiment of this invention.

FIG. 10, illustrates a perspective view of an inventive fluid measuring apparatus with the cover removed.

FIG. 11, illustrates a perspective view of an inventive tap adaptor apparatus that can be used with an inventive fluid measuring apparatus, according to this invention.

FIG. 12, illustrates a front view of an inventive fluid measuring apparatus, according to a ninth embodiment of this invention.

FIG. 13, illustrates a front view of an inventive fluid measuring apparatus, according to a tenth embodiment of this invention.

FIG. 14, illustrates a front view of an inventive fluid measuring apparatus, according to an eleventh embodiment of this invention.

### DETAILED DESCRIPTION

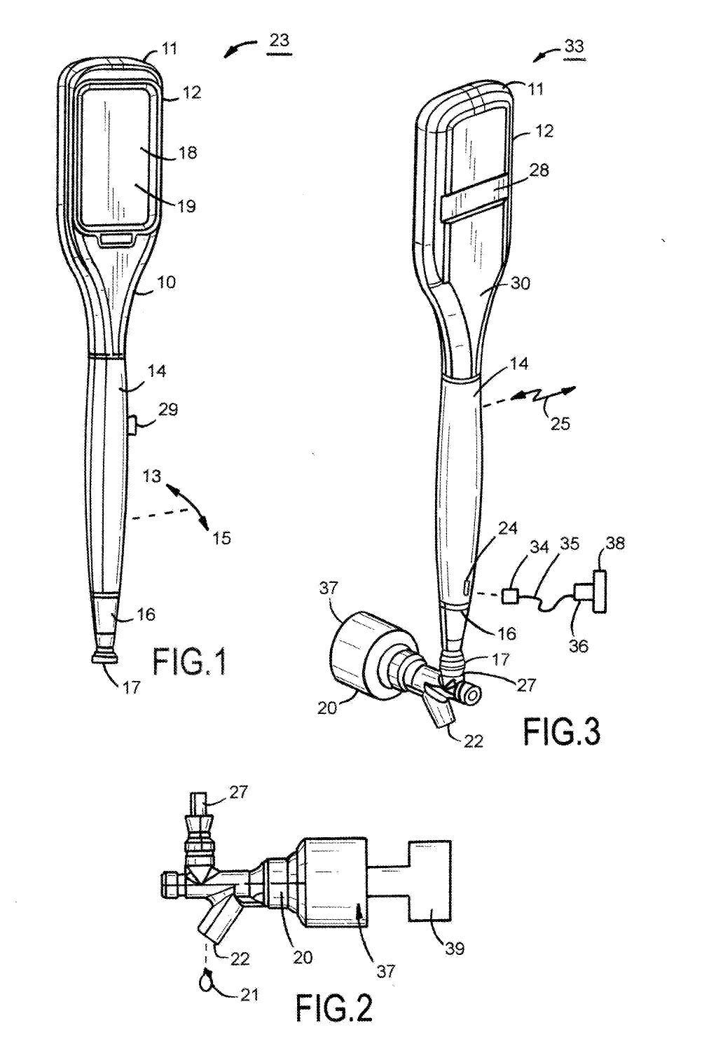

The inventive fluid measuring apparatus, system, and a method of using same will now be discussed with reference to FIGS. 1 through 14. Although the scope of the present invention is much broader than any particular embodiment, a detailed description of the preferred embodiment follows together with drawings. These drawings are for illustration purposes only and are not drawn to scale. Like numbers represent like features and components in the drawings.

FIG. 1, illustrates a perspective view of an inventive fluid measuring apparatus 23, according to one embodiment of this invention. The inventive fluid measuring apparatus 23, further comprises of a tap shell housing or handle 10, a cover 11, a tap head or frame 12, a tap stem 14, and a tap adaptor 16. The tap adaptor 16, could have a male or female connection 17. The tap head or frame 12, preferably has at least one display or screen 18. For some applications the display or screen 18, could be a touch sensitive display or screen 18. Additionally, for some applications the display or screen 18, could have at least one layer of a water or liquid resistant or repellent layer or material or cover 19, in order to protect the display or screen 18, from liquid or water damage, and also in helping to prevent cracks in the display screen 18. It should be appreciated that the tap shell housing 10, of the inventive fluid measuring apparatus 23, can be moved from a first position 13, to a second position 15. The movement of the tap shell housing 10, from the first position 13, to a second position 15, could be selected from a group comprising a vertical position, a horizontal position, a rotational position, a translational position, a sliding position, and combinations thereof, to name a few. For some applications one could optionally have a switch 29, such as, for example, an ON/OFF switch 29, an activation switch 29, a reset switch 29, to name a few, on the handle 10, or the tap shell housing 10.

FIG. 2, illustrates a side view of an inventive tap spigot system or apparatus 20, that provides a connection between the inventive fluid measuring apparatus 23, of FIG. 1, and a fluid dispenser 39. The inventive tap spigot apparatus 20, further comprises of a male or female connection 27, that is used to mate the inventive tap spigot apparatus 20, to the male or female connection 17, of the inventive fluid measuring apparatus 23, of FIG. 1. The inventive tap spigot apparatus 20, further has at least one line connecting means 37, at one end, that is used to connect to a line or keg or fluid dispenser 39, and a second end having at least one opening 22, or spigot opening 22, for the dispensing of at least one fluid 21, that is contained in the fluid dispenser 39. The male or female connection 17, of the tap threading adapter 16, also allows the inventive fluid measuring apparatus 23, to be attached to any preexisting tap line system 20, via the male or female connection 27. The fluid dispenser 39, could be a keg 39, or a beer keg 39, or a liquid holding container 39, or a beer dispensing container 39, to name a few. The fluid 21, could be beer 21, soda 21, water 21, or any other dispensable fluid 21, to name a few.

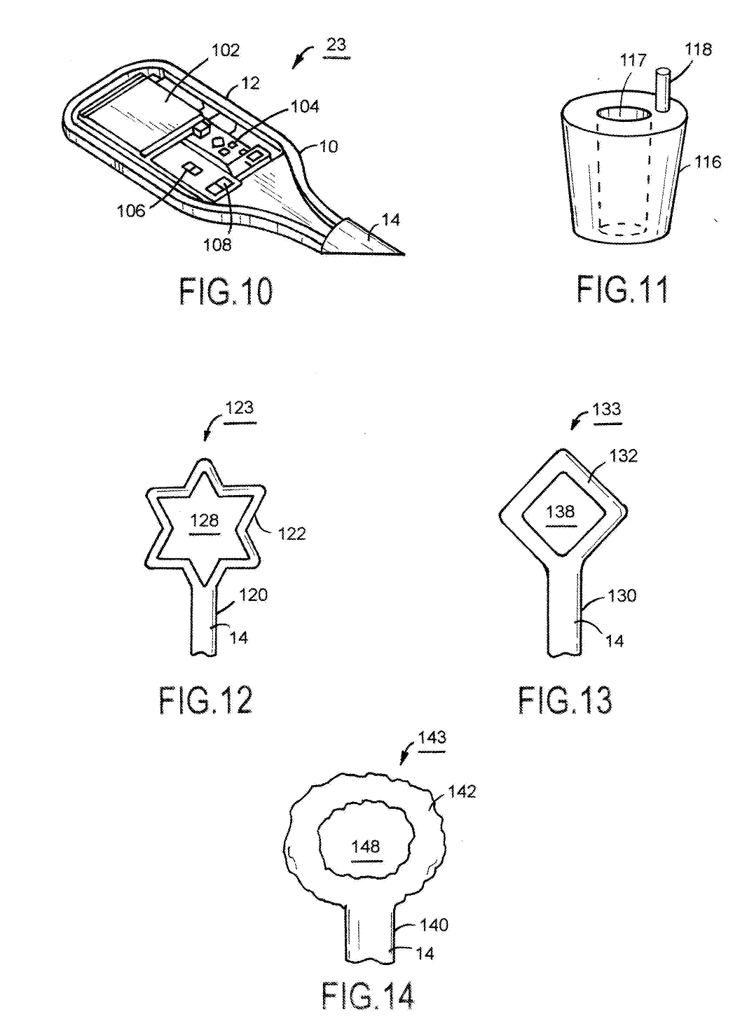

FIG. 3, illustrates a perspective view of an inventive fluid measuring apparatus 33, according to a second embodiment of this invention, which has been mated with an inventive tap spigot apparatus 20. The inventive fluid measuring apparatus 33, could have a tap shell housing 30, having at least one readout screen 28, and at least one electrical/data port 24, such as, a USB port 24, a charging port 24, an inlet port 24, an outlet port 24, to name a few. It should be appreciated that the use of ‘USB’ 24, can be changed to a charge port 24, a data port 24, a power source port 24, to name a few. For some applications an electrical wire 35, having a first connection 34, and a second connection 36, could be used to electrically connect the tap shell housing or tap handle 30, to an electrical source or another device 38, such that, the first connection 34, would be electrically connected to the port 24, while the second connection 36, would be electrically connected to the electrical source or another device 38. For some applications the tap shell housing 30, components or display device(s), may be linked to a closed network, such as, for example, a Wi-Fi 25, a Bluetooth 25, a wireless connectivity, through a device 38, such as, a computer 38, a tablet 38, a smartphone 38, or a similar such device 38, which allows the use or operator to change and/or edit pictures or texts digitally for the fluid measuring apparatus 33, to display, whether it is on screen 18, or screen 28, or a screen associated with the device 38. For some applications the tap handle 30, could be battery powered 102, as shown in FIG. 10, and could be charged, such as, via a charge or data port 34, such as, a USB plug 34, at the bottom of the tap handle 30, or a micro USB port 24, on the tap handle 30. The data/charge port and/or USB capability also allows the inventive fluid measuring apparatus 33, to be updated via a hard line 35, if anything were to happen to the wireless connectivity 25, WI-FI connectivity 25, and/or Bluetooth connectivity 25. For some applications the tap handle 30, could be controlled via a wireless connectivity 25, or a hard line wire 35, using a secondary electronic device 38. It should be appreciated that a computer software 38, an application 38, and/or a website 38, could be used to pair with the inventive fluid measuring apparatus 33, so as to create and/or edit and/or customize a producer-made label and/or logos that would be displayed, such as, on screen 18, 28. For some applications the tap shell housing 30, could have read-out screen 28, on one side of the tap head or frame 12, and a second or separate display screen 18, on the other or opposite side of the tap shell housing 30. The port 24, also allows for the charging of an onboard battery 102, if the battery 102, is rechargeable, along with data transfer, firmware updates, to name a few.

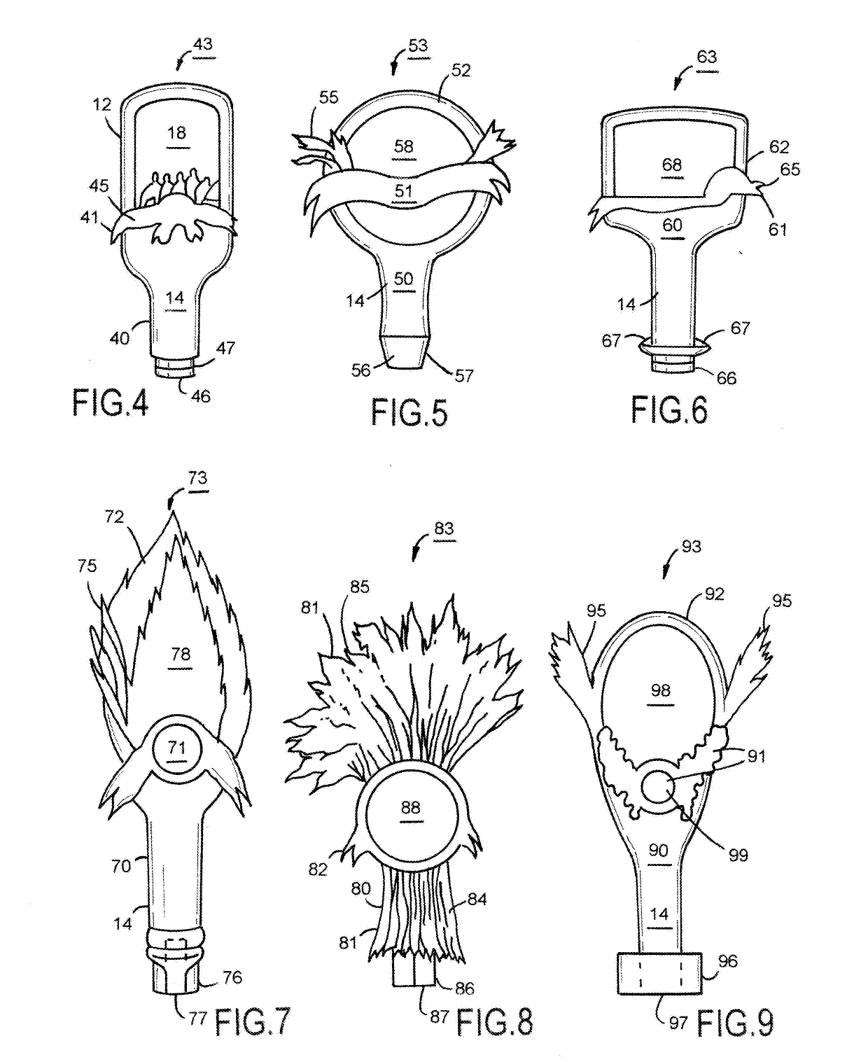

FIG. 4, illustrates a front view of an inventive fluid measuring apparatus 43, according to a third embodiment of this invention. The inventive fluid measuring apparatus 43, comprises of tap shell housing 40, having a tap adaptor 46, having a threaded and/or mate-able tap connection 47. For some applications the inventive fluid measuring apparatus 43, could have at least one decorative element 45, where the at least one decorative element 45, could be selected from a group comprising a ribbon-type image 45, a hops image 45, a wheat image 45, a barley image 45, a feather-type image 45, and combinations thereof, to name a few. Additionally, for some applications the inventive fluid measuring apparatus 43, could have at least one location to display at least one image 41, such as, a corporate logo 41, a branding logo 41, and combinations thereof, to name a few. The inventive fluid measuring apparatus 43, has the ability to display, such as, a beer logo 41, a beverage name 41, a photo 41, a GIF 41, a video 41, to name a few.

FIG. 5, illustrates a front view of an inventive fluid measuring apparatus 53, according to a fourth embodiment of this invention. The inventive fluid measuring apparatus 53, comprises of tap shell housing 50, having a tap adaptor 56, having a conical type tap connection 57, and a fancy or decorative tap head or frame 52, with a fancy or decorative display screen 58. For some applications the inventive fluid measuring apparatus 53, could have at least one decorative element 55, where the at least one decorative element 55, could be selected from a group comprising a ribbon-type image 55, a hops image 55, a wheat image 55, a barley image 55, a feather-type image 55, and combinations thereof, to name a few. Additionally, for some applications the inventive fluid measuring apparatus 53, could have at least one location to display at least one image 51, such as, a corporate logo 51, a branding logo 51, and combinations thereof, to name a few.

FIG. 6, illustrates a front view of an inventive fluid measuring apparatus 63, according to a fifth embodiment of this invention. The inventive fluid measuring apparatus 63, comprises of tap shell housing 60, having a tap adaptor 66, having at least one tap stopper 67, and/or at least one bayonet type connection 67, and a fancy or decorative tap head or frame 62, with a fancy or decorative display screen 68. For some applications the inventive fluid measuring apparatus 63, could have at least one decorative element 65, where the at least one decorative element 65, could be selected from a group comprising a ribbon-type image 65, a hops image 65, a wheat image 65, a barley image 65, a feather-type image 65, and combinations thereof, to name a few. Additionally, for some applications the inventive fluid measuring apparatus 63, could have at least one location to display at least one image 61, such as, a corporate logo 61, a branding logo 61, and combinations thereof, to name a few.

FIG. 7, illustrates a front view of an inventive fluid measuring apparatus 73, according to a sixth embodiment of this invention. The inventive fluid measuring apparatus 73, comprises of tap shell housing 70, having a tap adaptor 76, having a female tap connection 77, and a fancy or decorative tap head or frame 72, with a fancy or decorative display screen 78. For some applications the inventive fluid measuring apparatus 73, could have at least one decorative element 75, where the at least one decorative element 75, could be selected from a group comprising a ribbon-type image 75, a hops image 75, a wheat image 75, a barley image 75, a feather-type image 75, and combinations thereof, to name a few. Additionally, for some applications the inventive fluid measuring apparatus 73, could have at least one location to display at least one image 71, such as, a corporate logo 71, a branding logo 71, and combinations thereof, to name a few.

FIG. 8, illustrates a front view of an inventive fluid measuring apparatus 83, according to a seventh embodiment of this invention. The inventive fluid measuring apparatus 83, comprises of tap shell housing 80, having a tap adaptor 86, having a male tap connection 87, and a fancy or decorative tap head or frame 82, with a fancy or decorative display screen 88. For some applications the inventive fluid measuring apparatus 83, could have at least one decorative element 85, where the at least one decorative element 85, could be selected from a group comprising a ribbon-type image 85, a hops image 85, a wheat image 85, a barley image 85, a feather-type image 85, and combinations thereof, to name a few. Additionally, for some applications the inventive fluid measuring apparatus 83, could have at least one location to display at least one image 81, such as, a corporate logo 81, a branding logo 81, and combinations thereof, to name a few. For some applications the tap stem or handle 14, could be a decorative tap stem or handle 84. The decorative tap stem or handle 84, could also have at least one location to display at least one image 81, such as, a corporate logo 81, a branding logo 81, and combinations thereof, to name a few.

FIG. 9, illustrates a front view of an inventive fluid measuring apparatus 93, according to an eighth embodiment of this invention. The inventive fluid measuring apparatus 93, comprises of tap shell housing 90, having a tap adaptor 96, having a female tap connection 97, and a fancy or decorative tap head or frame 92, with a fancy or decorative display screen 98. For some applications the inventive fluid measuring apparatus 93, could have at least one decorative element 95, where the at least one decorative element 95, could be selected from a group comprising a ribbon-type image 95, a hops image 95, a wheat image 95, a barley image 95, a feather-type image 95, and combinations thereof, to name a few. Additionally, for some applications the inventive fluid measuring apparatus 93, could have at least one location to display at least one image 91, such as, a corporate logo 91, a branding logo 91, and combinations thereof, to name a few. For some applications the inventive fluid measuring apparatus 93, could have at least one additional or second screen or display 99.

FIG. 10, illustrates a perspective view of an inventive fluid measuring apparatus 23, with the cover 11, removed. The inventive fluid measuring apparatus 23, preferably has at least one power source 102, such as, a battery 102, a microprocessor 108, and at least one movement sensor 104, such as, for example, an accelerometer 104. The at least one movement sensor 104, records and is activated when the tap shell housing 10, is moved from a first position 13, to a second position 15, as illustrated in FIG. 1. For some applications the inventive fluid measuring apparatus 23, could also have at least one wireless data transfer unit 106, to transfer data to a second device 36, such as, another electronic device 36. The at least one power source 102, could be at least one battery 102, or a rechargeable battery 102. The microprocessor 108, could utilize connectivity 25, such as, for example, wireless connectivity 25, Wi-Fi connectivity 25, Bluetooth connectivity 25, to name a few, to allow a user or operator (not shown) to control and manage the images displayed on the display screen 18, 28, via a computer 38, a tablet 38, a smartphone 38, wirelessly 25, or via a push port 24. The accelerometer chip 104, or movement sensor 104, could be fastened or secured to the control board of the tap shell housing 10, and with the integration of the accelerometer 104, the tap shell housing will effectively track beer pouring or dispensing statistics in real time. Other features that can be extracted could be, for example, beer volume of the tapped keg, PSI (pounds per square inch) of the tap line 37, to allow for the calculation as to how much beer is being poured every time the tap handle 10, is pulled, etc. This additional information will allow proprietors, consumers, etc., to know how much beer they have poured and how much is left in the keg 39, or in the dispensing unit 39, in real time. This information can also be provided directly to distributors and brewers to give them more in depth data of how quickly the beverage is sold and by who.

It should be appreciated that the movement sensor 104, that is associated with the tap shell housing or handle 10, is sensitive enough that when the tap handle 10, is moved, such as, for example, from a first position 13, to a second position 15, it records not only the movement but also the duration. Thus, this allows the processing unit 108, that is connected to the movement sensor 104, to know or calculate, for example, how much fluid 21, or beer 21, was dispensed from the container 39, when the handle 10, was moved to allow the fluid 21, to pour out of the spigot opening 22.

FIG. 11, illustrates a perspective view of an inventive tap adaptor apparatus 116, that can be used with an inventive fluid measuring apparatus 23, according to this invention. For some applications the inventive tap adaptor apparatus 116, could also be used as a tap extender 116, between the tap adaptor 16, and the tap spigot system 20. The tap adaptor 116, could also have at least one opening 117, to act as a female connection 117, and/or at least one male connection 118. For some applications the tap adaptor 116, could be the same as the tap adaptor 16, or the tap adaptor 116, could be used to replace the tap adaptor 16.

FIG. 12, illustrates a front view of an inventive fluid measuring apparatus 123, according to a ninth embodiment of this invention. The inventive fluid measuring apparatus 123, comprises of tap shell housing 120, having a fancy or decorative or stylistic or themed tap head or frame 122, with a fancy or decorative or stylistic or themed display screen 128.

FIG. 13, illustrates a front view of an inventive fluid measuring apparatus 133, according to a tenth embodiment of this invention. The inventive fluid measuring apparatus 133, comprises of tap shell housing 130, having a fancy or decorative or stylistic or themed tap head or frame 132, with a fancy or decorative or stylistic or themed display screen 138.

FIG. 14, illustrates a front view of an inventive fluid measuring apparatus 143, according to an eleventh embodiment of this invention. The inventive fluid measuring apparatus 143, comprises of tap shell housing 140, having a fancy or decorative or stylistic or themed tap head or frame 142, with a fancy or decorative or stylistic or themed display screen 148.

The inventive static and dynamic display dispenser 23, 33, 43, 53, 63, 73, 83, 93, 123, 133, 143, for an in-line fluid flow, apparatus, system, and a method thereof, and more particularly directed to a digital tap stem or handle 10, 30, 40, 50, 60, 70, 80, 90, 120, 130, 140, for a beer dispensing apparatus 39, such as, a keg 39, a container 39, a pressurized container 39, to name a few.

In one aspect this invention is a tap stem or handle 10, 30, 40, 50, 60, 70, 80, 90, 120, 130, 140, that is integrated with at least one display or screen 18, 28, 48, 58, 68, 78, 88, 98, 128, 138, 148, and a microprocessor 108. One aspect of the inventive fluid measuring apparatus 23, 33, 43, 53, 63, 73, 83, 93, 123, 133, 143, is its ability to digitally display whatever the purveyor or supplier would like for the beverage name, logo, title, etc. they are offering.

For some applications the inventive fluid measuring apparatus 23, 33, 43, 53, 63, 73, 83, 93, 123, 133, 143, may have at least one read-out 28, on the back or opposite side to provide a user or an operator with data, such as, for example, beverage on tap 21, how much beer 21, in the keg 39, is left, how much battery life of the power source 102, is left, to name a few.

For some applications it is preferred that the working components, such as, the microprocessor 108, display 18, 28, 48, 58, 68, 78, 88, 98, 128, 138, 148, battery 102, chipset 106, accelerometer 104, may be encased in any type of waterproof or water resistant material 19, so as to prevent the working components to prematurely fail due to fluid contamination.

For some applications the software can be used to post in-depth information, such as, for example, flavor, ABV (alcohol by volume), hop level, IBU (International Bitterness Unit), SRM (Standard Reference Method), brewer information, in-house and/or national ratings, to name a few, such as, to a website, which will be accessible to patrons or requesters via an app or website 38. One could also have a website 38, that could be accessible to a patron via, for example, a scan-able QR (Quick Response) code, and that could, for example, display any promotions by the beverage company, or by the proprietor of facilities, or what is currently being offered at the facilities.

As stated earlier the use of a digital tap handle 23, or the fluid measuring apparatus 23, allows a purveyor or a supplier with the ability to engage their patrons with vibrant logos 91, 95, 99, and/or in-depth information about whatever beverage they choose. This information would allow a new element in the decision making process of a consumer by providing additional information that a traditional tap handle cannot provide. While the inventive tap stem or handle 10, is designed to display beer logos 45, 55, 65, 75, 85, 95, 125, 135, 145, or beverage name 45, 55, 65, 75, 85, 95, 125, 135, 145, it can also be used to display any potential advertising 41, 51, 61, 71, 81, 91, marketing 41, 51, 61, 71, 81, 91, or media 41, 51, 61, 71, 81, 91, the owner or operator of the tap handle 10, 30, 40, 50, 60, 70, 80, 90, 120, 130, 140, wishes to display. This invention also allows the purveyor the ability to properly advertise a rotating selection of beverages, as changes to the display will be possible at any time.

It should be appreciated that the tap read-out on the display screen 18, 28, 48, 58, 68, 78, 88, 98, 128, 138, 148, could be used for a variety of purposes, however, for some applications one could also have a digital read-out 18, 28, 48, 58, 68, 78, 88, 98, 128, 138, 148, on both sides of the tap shell housing 10, 30, 40, 50, 60, 70, 80, 90, 120, 130, 140.

The cross-sectional shape for the inventive tap head or frame 12, 52, 62, 72, 82, 92, 122, 132, 142, can be selected from a group comprising a triangular shape, a square shape, a rectangular shape, a circular shape, an oval shape, a polygonal shape, a cylindrical shape, a themed shape, a stylistic shape, a decorative shape, an abstract shape, and combinations thereof, to name a few.

The cross-sectional shape for the at least one inventive display or screen 18, 28, 58, 68, 78, 88, 98, 128, 138, 148, can be selected from a group comprising a triangular shape, a square shape, a rectangular shape, a circular shape, an oval shape, a polygonal shape, a cylindrical shape, a themed shape, a stylistic shape, a decorative shape, an abstract shape, and combinations thereof, to name a few.

The integration of the inventive fluid measuring apparatus 23, also provides the proprietor with the ability to immerse their patrons or customers with, for example, vibrant logos 91, 95, 99, and in depth information about whatever beer they are drinking. It should be appreciated that while the tap shell housing is designed to display beer logos 41, 51, 61, 71, 81, 91, it can also be used to display any potential advertising, marketing or media that the owner or proprietor of the tap wishes to display 41, 51, 61, 71, 81, 91.

The in-line fluid flow measuring apparatus 23, having the tap shell housing 10, has at least one electronic port 24, and wherein the at least one electronic port 24, is selected from a group comprising an electrical port 24, a USB port 24, a mini USB port 24, a micro USB port 24, a charging port 24, a data port 24, a power source port 24, and combinations thereof, to name a few.

The in-line fluid flow measuring apparatus 23, having the tap shell housing 10, has at least one location to display at least one image 41, 45, 51, 55, 61, 65, 71, 75, 81, 84, 85, 91, 95, 99, and wherein the at least one image 41, 45, 51, 55, 61, 65, 71, 75, 81, 84, 85, 91, 95, 99, is selected from a group comprising of a corporate logo, a branding logo, a beer logo, a beverage name, a photograph, a GIF (Graphics Interchange Format) image, a video, and combinations thereof, to name a few.

The tool used in the preset invention, namely, the inventive fluid measuring apparatus 23, 33, 43, 53, 63, 73, 83, 93, 123, 133, 143, may be implemented using one or more computers 38, executing software instructions. According to one embodiment of the present invention, the inventive fluid measuring apparatus 23, 33, 43, 53, 63, 73, 83, 93, 123, 133, 143, may communicate with server and client computer systems 38, that transmit and receive data over a computer network 35, or a fiber or copper-based telecommunications network 35, or other forms of data transfer networks 35, or wireless network 25. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers 38, from a storage device 38, or from one or more other computer systems 38, over a network connection 25, 35. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the CPU may directly support the downloaded instructions. In other cases, the instructions may not be directly executable by the CPU, and may instead be executed by an interpreter that interprets the instructions. In other embodiments, hardwired circuitry may be used in place of, or in combination with, software instructions to implement the present invention. Thus tools used in the present invention are not limited to any specific combination of hardware circuitry and software, nor to any particular source for the instructions executed by the server or client computers. In some instances, the client and server functionality may be implemented on a single computer platform.

Thus, the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Still further, while certain embodiments of the inventions have been described, these embodiments have been presented by way of example only, and are not intended to limit the scope of the inventions. Indeed, the novel apparatus, methods, and systems, described herein may be embodied in a variety of other forms; furthermore, various omissions, substitutions and changes in the form of the methods and systems described herein may be made without departing from the spirit of the inventions.

It should be further understood that throughout the specification and claims several terms have been used and they take the meanings explicitly associated herein, unless the context clearly dictates otherwise. For example, the phrase “in one embodiment” as used herein does not necessarily refer to the same embodiment, though it may. Additionally, the phrase “in another embodiment” as used herein does not necessarily refer to a different embodiment, although it may. Thus, various embodiments of the invention may be readily combined, without departing from the scope or spirit of the invention.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. An in-line fluid flow measuring apparatus, comprising,
(a) a tap shell housing having a tap stem at one end, and a tap head at an opposite end;
(b) said tap head having at least one digital display screen;
(c) said tap stem having a tap adaptor, wherein said tap adaptor securely engages with a tap spigot system; and
(d) said spigot system having at least one line connection with at least one fluid dispenser at one end, and at least one opening at an opposite end for dispensing of said at least one fluid.

2. The in-line fluid flow measuring apparatus of claim 1, wherein said tap shell housing is capable of being moved from a first position to a second position.

3. The in-line fluid flow measuring apparatus of claim 1, wherein said tap shell housing is capable of being moved from a first position to a second position, and wherein said movement from said first position to said second position allows for said dispensing of said at least one fluid via said at least one opening in said spigot system.

4. The in-line fluid flow measuring apparatus of claim 1, wherein said tap shell housing is capable of being moved from a first position to a second position, and wherein said movement from said first position to said second position is selected from a group consisting of a rotational movement, a translational movement, a sliding movement, and combinations thereof.

5. The in-line fluid flow measuring apparatus of claim 1, wherein said at least one fluid is selected from a group consisting of beer, beverage, water, carbonated beverage, dispensable fluid, and combinations thereof.

6. The in-line fluid flow measuring apparatus of claim 1, wherein said tap shell housing has at least one electronic port.

7. The in-line fluid flow measuring apparatus of claim 1, wherein said tap shell housing has at least one electronic port, and wherein said at least one electronic port is selected from a group consisting of an electrical port, a USB port, a mini USB port, a micro USB port, a charging port, a data port, a power source port, and combinations thereof.

8. The in-line fluid flow measuring apparatus of claim 1, wherein at least one decorative element is secured to said tap shell housing.

9. The in-line fluid flow measuring apparatus of claim 1, wherein at least one decorative element is secured to said tap shell housing, and wherein said at least one decorative element is selected from a group consisting of a ribbon-type image, a hops image, a wheat image, a barley image, a feather-type image, and combinations thereof.

10. The in-line fluid flow measuring apparatus of claim 1, wherein said tap shell housing has at least one location to display at least one image.

11. The in-line fluid flow measuring apparatus of claim 1, wherein said tap shell housing has at least one location to display at least one image, and wherein said at least one image is selected from a group consisting of a corporate logo, a branding logo, a beer logo, a beverage name, a photograph, a GIF (Graphics Interchange Format) image, a video, and combinations thereof.

12. The in-line fluid flow measuring apparatus of claim 1, wherein said at least one fluid dispenser is selected from a group consisting of a beer dispenser, a keg, a beverage dispenser, a container, and a pressurized container 39.

13. The in-line fluid flow measuring apparatus of claim 1, wherein at least one tap extender is secured between said tap adaptor, and said spigot system.

14. The in-line fluid flow measuring apparatus of claim 1, wherein a shape of said tap head is selected from a group consisting of a triangular shape, a square shape, a rectangular shape, a circular shape, an oval shape, a polygonal shape, a cylindrical shape, a themed shape, a stylistic shape, a decorative shape, a fancy shape, and a stylistic shape.

15. The in-line fluid flow measuring apparatus of claim 1, wherein a shape of said at least one digital screen is selected from a group consisting of a triangular shape, a square shape, a rectangular shape, a circular shape, an oval shape, a polygonal shape, a cylindrical shape, a themed shape, a stylistic shape, a decorative shape, a fancy shape, and a stylistic shape.

16. The in-line fluid flow measuring apparatus of claim 1, wherein said tap shell housing houses at least one power source, at least one microprocessor, at least one data transfer unit, and at least one movement sensor.

17. The in-line fluid flow measuring apparatus of claim 1, wherein said tap shell housing has at least one first electronic component, and wherein said at least one electronic component communicates with at least one second electronic component, and wherein said communication is done via at least one means selected from a group consisting of a Wi-Fi, a Bluetooth connection, a wireless connectivity, and a wired connection.

18. The in-line fluid flow measuring apparatus of claim 1, wherein said tap shell housing has at least one electrical device to measure a movement from a first position to a second position of said tap shell housing, and to calculate an amount of said dispensed fluid.

19. An in-line fluid flow measuring apparatus, comprising,
(a) a tap shell housing having a tap stem at one end, and a tap head at an opposite end;
(b) said tap head having at least one digital display screen;
(c) said tap stem having a tap adaptor, wherein said tap adaptor securely engages with a tap spigot system;
(d) said spigot system having at least one line connection with at least one fluid dispenser at one end, and at least one opening at an opposite end for dispensing of said at least one fluid; and
(e) at least one movement sensor secured to said tap shell housing, and wherein said at least one movement sensor measures a movement and duration from a first position to a second position of said tap shell housing, and uses said measured information to calculate an amount of said at least one fluid that has been dispensed via said at least one opening of said spigot system.

20. A method of measuring an in-line fluid flow, comprising,
(a) providing a tap shell housing having a tap stem at one end, and a tap head at an opposite end;
(b) securing at least one digital display screen to said tap head;
(c) providing at least one tap adaptor between said tap stem and a tap spigot system, wherein said spigot system has at least one line connection with at least one fluid dispenser at one end, and at least one opening at an opposite end for dispensing of said at least one fluid; and
(d) securing at least one movement sensor to said tap shell housing, and wherein said at least one movement sensor measures a movement and duration from a first position to a second position of said tap shell housing when said tap shell housing is moved, and uses said measured information to calculate an amount of said at least one fluid that has been dispensed via said at least one opening of said spigot system.
